(19) United States
(12) Patent Application Publication
(10) Pub. No.: US 2007/0250625 A1
(43) Pub. Date: Oct. 25, 2007

(54) Real-time services network quality control

(76) Inventor: Timothy G. Titus, Sunnyvale, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/796,092

(22) Filed: Apr. 25, 2007

Related U.S. Application Data
(60) Provisional application No. 60/795,146, filed on Apr. 25, 2006.

(51) Int. Cl. G06F 15/173

(52) U.S. Cl. 709/224; 709/223

(57) ABSTRACT

A network quality control system includes a user control console to probe, calculate, and display the quality of an enterprise's network connections to remote SNMP managed devices supporting real-time services like VoIP. Traceroute-like messages are sent to each remote SNMP managed device to report on the path, and hop latency, jitter, and packet losses. MOS scores are computed to indicate performance with a variety of available codec's. Empty test packets used simply to probe network quality are not used. Instead, SNMP messages that carry valuable information or commands for other purposes are gleaned of timing information so the MOS quality scores can be calculated in background.

### CROSS REFERENCE TO OTHER APPLICATIONS

This application claims the benefit of U.S. provisional patent application No. 60/795,146. filed Apr. 25, 2006, the disclosure of which is hereby incorporated by reference in its entirety.

### FIELD OF THE INVENTION

This invention relates to the Internet, and especially to methods and devices for improving and assessing the quality of network connections supporting real-time services like streaming video and VOIP telephone calls.

### BACKGROUND

The networking industry is rapidly converting to providing packet based real-time services like Voice over IP (VoIP) and live video over IP. VoIP telephone services are rapidly expanding worldwide and threatening traditional telephone services because they mimic ordinary telephone devices and use, but provide very affordable and reliable calling. Typical plans cost $29 a month for simple unlimited calling free throughout the United States and Canada, and exceptionally low per-minute rates to Europe and Asia. Some of the telephone sets can implemented as downloadable software to a laptop computer with a microphone and headphones, and other configurations allow ordinary telephones to be plugged in with a standard RJ-11 modular jack to a home broadband router, e.g., a Linksys Wireless-G WRT54GP2A-AT with two VoIP jacks.

Businesses are now able to set-up virtual PBX networks in which some of the company's subscriber “extensions” are actually located at an employee's home and connected through a typical Linksys or Netgear broadband router. Such routers are ubiquitous in American and European homes, and a large fraction of these already support simple network protocol (SNMP) communication. Only the very inexpensive VoIP adapters do not already include SNMP.

Global communication network operators, located at a few centralized network management centers, are relying more and more on automated network management applications to analyze, process, display and support their networks. An increasing number of network management software applications are being marketed that use open-system standardized protocols. Particular network application tool software is possible to report lists of the network appliances, by location, and can issue trouble lists and keep track of software versions and releases. SNMP applications are conventionally used to issue alarms to central management consoles when remote network appliances fail.

According to the Carnegie-Mellon Software Engineering Institute, SNMP is a network management specification developed by the Internet Engineering Task Force (IETF) in the mid 1980s to provide standard, simplified, and extensible management of LAN-based internetworking products such as bridges, routers, and wiring concentrators. An object was to reduce the complexity of network management, and to minimize the resources needed to support it. SNMP provides for centralized, robust, interoperable network management, along with the flexibility to allow for the management of vendor-specific information. SNMP as a communication specification defines how management information can be exchanged between network management applications and management agents. There are several versions of SNMP, two of the most common are SNMPv1, and SNMPv2. SNMPv1 is a simple message-based request/response application-layer protocol that uses the User Datagram Protocol (UDP) for data delivery.

SNMPv1 network management architecture includes a Network Management Station (NMS) workstation to hosts the network management application. The SNMPv1 network management application polls management agents for information and provides control information to agents. A Management Information Base (MIB) defines the information that to be collected and controlled by the management application. Each SNMPv1 management agent provides information contained in the MIB to the management applications and can accept control information. The MIB is a database of managed objects residing on the agent. Managed objects can be monitored, modified or controlled, e.g., a threshold, network address or counter. The management application or user can define the relationship between the SNMPv1 manager and the management agent. The GET_NEXT_REQUEST requests the next object instance from a table or list from an agent. The GET_RESPONSE is the returned answer to get_next_request, get_request, or set_request. The GET_REQUEST asks for the value of an object instance from the agent. The SET_REQUEST fixes the value of an object instance within an agent. The TRAP sends trap (event) asynchronously to network management application. Agents can conditionally send a trap when a trigger has occurred, e.g., a change in state of a device, device failure or agent initialization/restart. SNMP specifies the protocol to be used between a network management application and each management agent. It allows software and managed devices from different vendors to be managed by one SNMP network management application. A “proxy function” in SNMP enables communication with non-SNMP devices to accommodate legacy equipment.

SNMP is simple to implement, and it does not require large computational or memory resources from the devices that do accommodate it. SNMP network management is based on polling and asynchronous events. Each SNMP manager polls for information gathered by the agents. Each agent collects local information and stores it in the agent's own MIB. Such information is then sent later to the SNMP manager in response to the manager's polling. SNMP events (alerts) are driven by trap messages generated as a result of certain device parameters. These parameters can be either generic or vendor device specific. Enterprise-specific trap messages are vendor proprietary and generally provide more device-specific detail.

SNMPv1 has been incorporated into many products and management platforms. It has been deployed by virtually all internetworking vendors. It has been widely adopted for the enterprise business organization networks. It is well-suited for managing TCP/IP networks. SNMPv1 uses the underlying User Datagram Protocol (UDP) for data delivery, which does not ensure reliability of data transfer. The loss of data may be a limitation to a network manager, depending on the criticality of the information being gathered and the frequency at which the polling is being performed.

SNMP is best suited for network monitoring and capacity planning. SNMP does not provide even the basic troubleshooting information that can be obtained from simple network troubleshooting tools. SNMP agents do not analyze information, they just collect information and provide it to the network management application.

SNMPv1 has minimal security capability. Because SNMPv1 lacks the control of unauthorized access to critical network devices and systems, it may be necessary to restrict the use of SNMP management to non-critical networks. Lack of authentication in SNMPv1 has led many vendors to not include certain commands, thus reducing extensibility and consistency across managed devices. SNMPv2 addresses these security problems but is difficult and expensive to set up and administer (e.g., each MIB must be locally set up).

Vendors often include SNMP agents with their software and public domain agents are available. Management applications are available from a variety of vendors as well as the public domain, however they can differ greatly in terms of functionality, plots and visual displays.

SNMP out-of-the-box can not be used to track information contained in application/user level protocols (e.g., radar track message, http, mail). However these might be accomplished through the use of a extensible (customized) SNMP agent that has user defined MIB.5 It is important to note that a specialized or extensible network manager may be required for use with the customized agents.

There are also concerns about the use of SNMP in the real-time domain where bounded response, deadlines, and priorities are required.

SNMPv2 is intended to be able to coexist with existing SNMPv2, but in order to use SNMPv2 as the SNMP manager or to migrate from SNMPv1 to SNMPv2, all SNMPv1 compliant agents must be entirely replaced with SNMPv2 compliant agents-gateways or bilingual managers and proxy agents were not available to support the gradual migration as of early-1995. Since SNMPv1 and SNMPv2 are incompatible with each other and SNMPv2 is not stable, it is important when procuring a managed device to determine which network management protocol(s) is supported.

SNMP is conventionally used to send messages between management client nodes and agent nodes. Management information blocks (MIB's) are used for statistic counters, port status, and other information about routers and other network devices. GET and SET commands are issued from management consoles and operate on particular MIB variables for the equipment nodes. Such commands allow network management functions to be carried out between client equipment nodes and management agent nodes. The agent nodes can issue alert or TRAP messages to the management center to report special events.

SNMP is an application protocol for network management services in the internet protocol suite. SNMP has been adopted by numerous network equipment vendors as their main or secondary management interface. SNMP defines a client/server relationship, wherein the client program, a “network manager”, makes virtual connections to a server program, an “SNMP agent”, on a remote network device. The data base controlled by the SNMP agent is the SNMP management information base, and is a standard set of statistical and control values. SNMP and private MIB's allow the extension of standard values with values specific to a particular agent. Directives issued by the network manager client to an SNMP agent comprise SNMP variable identifiers, e.g., MIB object identifiers or MIB variables, and instructions to either GET the value for the identifier, or SET the identifier to a new value. Thus private MIB variables allow SNMP agents to be customized for specific devices, e.g., network bridges, gateways, and routers. The definitions of MIB variables being supported by particular agents are located in descriptor files, typically written in abstract syntax notation (ASN.1) format. The definitions are available to network management client programs.

SNMP is a standard TCP/IP protocol providing for network management. SNMP is used by network administrators to monitor and map network availability, performance, and error rates. SNMP network devices use a Management Information Base (MIB) distributed data store. SNMP compliant devices include a MIB that describes the device attributes. Some attributes are fixed or “hard coded” in the MIB, and others are dynamic values calculated by agent software running on the device. Tivoli, HP OpenView, and other enterprise network management software use SNMP commands to read and write data in each device MIB. The so-called “Get” command retrieves data, and the “Set” command initiate some action on the device. For example, a “system reboot” command is implemented by defining a particular MIB attribute and issuing an SNMP Set from the manager software to write a “reboot” value into that attribute. SNMP was developed in the 1980's. The original version, SNMPv1, was too simple and only worked with TCP/IP networks. The improved specification, SNMPv2, was developed in 1992. SNMP suffers from various flaws of its own, so many networks remained on the SNMPv1 standard while others adopted SNMPv2. More recently, SNMPv3 specification was completed in an attempt to address the problems with SNMPv1 and SNMPv2 and allow administrators to move to one common SNMP standard.

VOIP connection quality depends on end-to-end network latency,jitter, dropped packets, and the choice of coder/decoder (codec) being used. There are at least a half dozen different codec's that can be used, and at least one of them will be better than the others given a particular network quality mix. Each has benefits and drawbacks depending on how they are implemented, and what sort of network qualities affect them. Network tools that enable technicians to measure the various network quality parameters can be used to help choose which codec's and which Internet service providers (ISP'S) are best to use.

Real-time services make some unique demands on networks, e.g., low packet latencies so the information is able to arrive at the receiver's location on-time. The incurred latency must also be stable, low jitter, so packets arrive at the receiver's location at regular intervals. Networks must also have very low packet loss so enough information is available to reconstruct the communications activity.

To make networks reliable enough for real-time service, the networking industry has created test suites that combine codec, latency, jitter, and packet loss readings into a single score to describe the communications quality on links. The mean opinion score (MOS) is a popular method of quality rating a link. The MOS can be calculated with software written to the ITU-T G.107E-model. Such software inputs codec, latency, jitter, and packet loss into its calculations. In Internet voice communications, the MOS provides a numerical measure of the quality of human speech at the destination end of the circuit. The scheme uses subjective tests, opinionated scores, that are mathematically averaged to obtain a system performance quantitative indicator. Compressor/decompressor (codec) systems and digital signal processing (DSP) are used in voice communications to conserve bandwidth, but at the cost of voice fidelity. The best codec's provide the most bandwidth conservation while producing the least degradation of the signal. Bandwidth can be measured using laboratory instruments, but voice quality is subjective. To determine MOS, a number of listeners rate the quality of test sentences read aloud over the communications circuit by male and female speakers. A listener gives each sentence a rating of (1) bad; (2) poor; (3) fair; (4) good; (5) excellent. The MOS is the arithmetic mean of all the individual scores, and ranges 1-5, worst to best.

A number of companies market hardware and software based solutions that require hardware-based network agents to be periodically deployed around a network. These appliances test latency, jitter and packet loss between agents to gather their measurements. An MOS score is calculated assuming various different codec's, e.g., to help determine which codec will provide the best results in particular applications. But after the latency, jitter, or packet losses are determined to be too high, this type of test will not identify what is the actual source or cause of the problem.

Other solutions, like SmokePing, measure latency,jitter, and packet loss from one system to any other system that will respond to an ICMP echo request. SmokePing monitors and graphs network latency. According to information obtained from http://directory.fsf.org/SmokePing.html, SmokePing measures network latency out to a configurable set of destinations on the network, and then displays its findings in web pages. It has a daemon process for data collection and a CGI script presenting the data on the web. SmokePing can also watch for loss/latency patterns and issue alerts when it finds a match. This allows for sophisticated monitoring applications. SmokePing deals with machines that frequently change their IP address by allowing the remote host to call SmokePing's attention to its new IP address. SmokePing also monitors how long the remote system could keep its IP address, and tries to fingerprint each Dynamic IP targets via SNMP too ensure that it is not suddenly monitoring the wrong host.

SmokePing uses the RRDtool as its logging and graphing back-end. Such system is very efficient. Data is presented on the Web through a CGI which generates graphs on demand. The CGI script uses SpeedyCGI to achieve mod_perl like performance without actually needing to load mod_perl on the server. SmokePing has a plug-in architecture so new latency measurement capabilities can be easily added to the package. SmokePing is an especially good solution, because it does not require agent appliances to be installed around the network.

Nevertheless, conventional solutions all share the common disadvantage of sending empty packets out on the network to test the conditions. Even though these test packets tend to be small, they can take away limited network bandwidth on already impacted links.

What is needed are devices and methods that can monitor network latency, jitter, and packet loss for each monitored device, and that can collect other useful information from the end device during the process. Ideally, bandwidth will not be wasted with numerous test packets, and critical information can be gathered by the monitoring station to help isolate and identify the causes of the problems.

### SUMMARY OF THE INVENTION

In an example embodiment, an application program is downloaded for a subscription fee over the Internet to a WINDOWS-XP computer. Once installed, the application program displays a browser window type graphical user interface (GUI) as a control console. It installs an SNMP manager that collects mean opinion score (MOS) statistics and path information related to a number of remote VoIP clients. Each such client has an SNMP router that can respond to the SNMP manager. The SNMP communication provides network quality information about packet latency, jitter, and number of dropped packets. A pathway utility manipulates the TTL field in the packets being sent out to point-by-point discover the ISP-to-ISP pathways taken by various VoIP connections to the clients. The MOS statistics and other data are supplied in a browser GUI to an enterprise administrator console for selection of particular codec's and ISP's that will provide optimum quality.

The above summary of the present invention is not intended to represent each disclosed embodiment, or every aspect, of the present invention. Other aspects and example embodiments are provided in the figures and the detailed description that follow.

### BRIEF DESCRIPTION OF THE DRAWINGS

The invention may be more completely understood in consideration of the following detailed description of various embodiments of the invention in connection with the accompanying drawings, in which:

FIG. 1 is a functional block diagram of a network quality assessment system embodiment of the present invention;

FIG. 2 is a schematic diagram of a first pathway process embodiment of the present invention showing how each ISP in the connection between the enterprise and client 104 is probed and cataloged;

FIG. 2 is a schematic diagram of a second pathway process embodiment of the present invention showing how each ISP in the connection between the enterprise and client 106 is probed and cataloged; and

FIG. 4 is a functional block diagram of a downloadable network quality assessment tool similar to that described in FIGS. 1-3.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

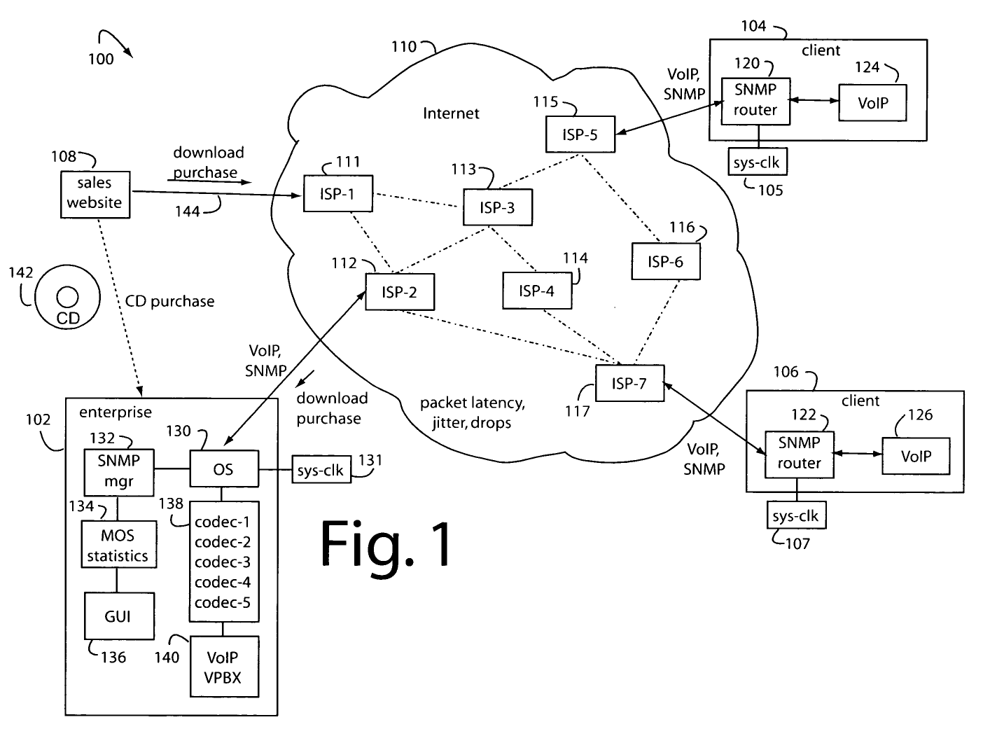

FIG. 1 shows a network quality assessment system embodiment of the present invention, and is referred to herein by the general reference numeral 100. In this instance, the system 100 supports a virtual private branch exchange (VPBX) implementation that allows a business enterprise to incorporate PBX-type telephone extensions at employee homes and/or remote branch offices. Such VPBX requires higher than usual network connection quality to support inter-company communications. Voice over Internet Protocol (VOIP) as well as video services can be accommodated. The system 100 comprises a business enterprise 102 with many remote clients, e.g., 104 and 106. A sales website 108 is present on the Internet 110, which includes many inter-meshing Internet service providers (ISP's), e.g., ISP-1 to ISP-7, 111-17. Each client 104, 106, includes a commercial, off-the-shelf wireless router 120, 122, with SNMP support, and a VoIP port 124, 126.

The enterprise 102 includes an operating system 130 like WINDOWS-XP, a local system clock (sys-clk) 131, an SNMP manager 132, a MOS statistics collection and calculation module 134, and a graphical user interface (GUI) 136. A collection of different codec's 138 are available to the user that each perform differently depending on the exact quality character of the network connection through the Internet 110. One codec will be a best choice for a given set of latencies, jitter, and numbers of packets dropped.

The enterprise 102 includes a monitoring station function that sends an SNMP packet to each end point of interest, e.g., remote client 104 with local system clock (sys-clk) 105, and remote client 106with local system clock (sys-clk) 107. Such packets may include a request for any type of SNMP information obtainable. The SNMP response packets from the end points are returned to the monitoring station. The round-trip latency is measured, and repeated more than once to determine the jitter on the link. Manageable end-point devices can be wireless broadband routers, switches, bridges, network probes, VoIP phones, analog telephony attachment (ATA), PBX, computer, etc. Application software uses network management protocol to query one or more data elements from the device. During this communication, the round-trip latency of the request would be tracked for each request. Successive requests allow the inter-packet jitter to be determined. Missing or lost requests are detected so a packet loss count can be determined as well. Latency, jitter, and packet loss can be gleaned from any communication to the manageable devices, pure test packets are wasteful and not necessary. The information is combined with a codec to create a Mean Opinion Score (MOS) for the communications stability of each link.

System 100 permits the analysis of latency, jitter, and packet loss over uncontrolled networks like the Internet. The payload may optionally be a request for the device's system time. The device and monitoring station system clocks are synchronized, so the uni-directional latency can be calculated by subtracting the return trip time from the overall round-trip latency. The traceroutes to the managed devices are regularly computed. The number of hops are counted, and the latency between the hops is tracked. Reports are viewable for latency changes for interim hops, and changes in routes that would affect the hop count of packets reaching the destination.

Alerts are issued if latency, jitter, or packet losses rise above specified thresholds, or if the MOS calculated with a specific codec is too low for a specific monitored device. The alert could be in the form of an email, syslog message, SMS message, instant message, SNMP trap, or other alert mechanism.

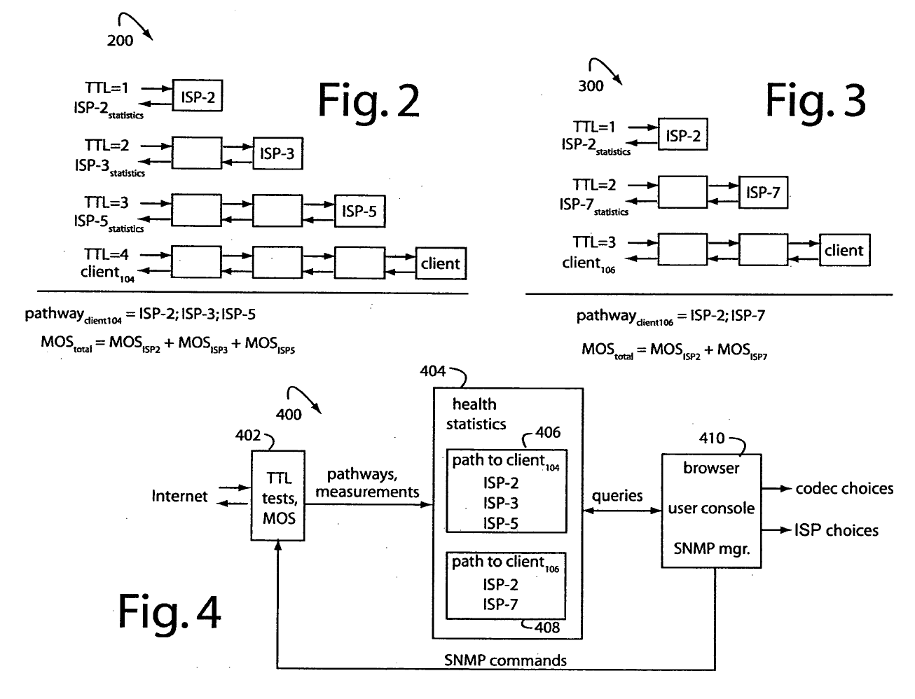

FIG. 2 illustrates a pathway process 200 in an example of how system 100 identifies the connection pathways through the Internet to the various clients. It also collects statistics for each ISP along the path by manipulating the time-to-live (TTL) value in a series of Internet Protocol (IP) packets sent to each client.

According to searchNetworking.com definitions, TTL is a value in an IP packet that tells a network router whether or not the packet has been in the network too long and should be discarded. For a number of reasons, packets may not get delivered to their destination in a reasonable length of time. For example, a combination of incorrect routing tables could cause a packet to loop endlessly. A solution is to discard the packet after a certain time and send a message to the originator, who can decide whether to resend the packet. The initial TTL value is set, usually by a system default, in an 8-binary digit field of the packet header. The original idea of TTL was that it would specify a certain time span in seconds that, when exhausted, would cause the packet to be discarded. Since each router is required to subtract at least one count from the TTL field, the count is usually used to mean the number of router hops the packet is allowed before it must be discarded. Each router that receives a packet subtracts one from the count in the TTL field. When the count reaches zero, the router detecting it discards the packet and sends an Internet Control Message Protocol (ICMP) message back to the originating host. The default Windows 95/98 TTL value is 32 hops. Some users recommend changing this to 128 if users have difficulty reaching certain sites. The ping and the traceroute utilities both make use of the TTL value to attempt to reach a given host computer or to trace a route to that host. Traceroute intentionally sends a packet with a low TTL value so that it will be discarded by each successive router in the destination path. The time between sending the packet and receiving back the ICMP message that it was discarded is used to calculate each successive hop travel time. Using the multicast IP protocol, the TTL value indicates the scope or range in which a packet may be forwarded. By convention: 0 is restricted to the same host; 1 is restricted to the same subnet; 32 is restricted to the same site; 64 is restricted to the same region; 128 is restricted to the same continent; and, 255 is unrestricted

The pathway process 200 is set to document the pathway from enterprise 102 (FIG. 1) to client 104. Under normal circumstances, users will not know which ISP's were involved in handling their packet traffic. But by manipulating the TTL values, starting at 1, the first, second, third, etc., ISP's to handle the connection can be logged one-by-one. Their respective MOS measures can also be determined and cataloged. The whole pathway to each client is thereby measured. For example, in process 200 TTL is set to 1, and ISP-2 immediately returns the ICMP message identifying itself. The packet delays are measured and stored. The TTL is then set to 2, and ISP-3 returns the ICMP message identifying itself. The previous hops were not identified in this ICMP message, but it can be assumed that the path to ISP-3 was through ISP-2, so packet delay measurements from ISP-3 will deduct those that were previously obtained for ISP-2. The TTL is then set to 3, and ISP-5 returns the ICMP message identifying itself. Again, the previous hops are not identified in this ICMP message, but it can be assumed that the path to ISP-5 was through ISP-2 and ISP-3, so packet delay measurements from ISP-5 will deduct those that were previously obtained. The TTL is then set to 4, and client 104 receives the packet. An acknowledgement is returned. It is assumed that the path to client 104 was through ISP-2, ISP-3, and ISP-5, so packet delay measurements, and other MOS statistics from the SNMP client 104 will be cataloged as such.

In FIG. 3, a pathway process 300 is set to document the pathway from enterprise 102 (FIG. 1) to client 106. For example, in process 300 TTL is set to 1, and ISP-2 immediately returns the ICMP message identifying itself. The packet delays are measured and stored. The TTL is then set to 2, and ISP-7 returns the ICMP message identifying itself. It is assumed that the path to ISP-7 was through ISP-2, so packet delay measurements from ISP-7 will deduct those that were previously obtained for ISP-2. The TTL is then set to 3, and client 106 receives the packet. It is assumed that the path to client 106 was through ISP-2 and ISP-7, so packet delay measurements, and other MOS statistics from the SNMP client 106 will be cataloged. All the rest of the SNMP clients are probed, measured, and cataloged this way. Such can be on a regular schedule, and the IP addresses of each SNMP client belonging to a particular enterprise can be automatically obtained without requiring manual entries.

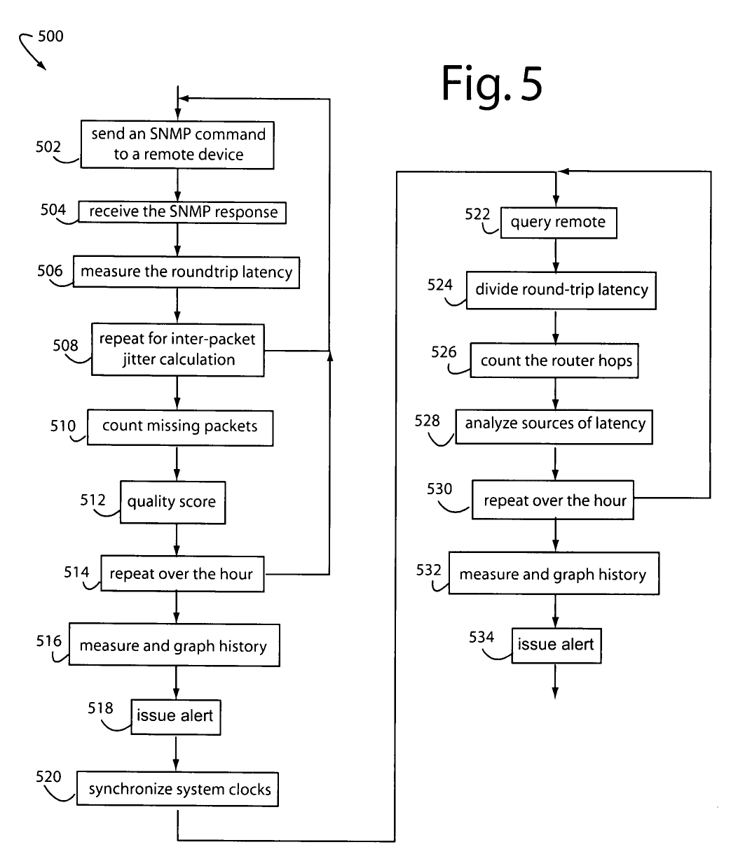

FIG. 4 represents a downloadable network quality assessment tool embodiment of the present invention, and is referred to herein by the general reference numeral 400. Such comprises a TTL and MOS probe 402 that sends out packets on the Internet directed to particular clients. The TTL values are manipulated to one-by-one discover the ISP's in the network pathway to each client, and to collect latency, jitter, and dropped packet statistics. MOS values are computed. These determinations and measurements are forwarded to a health statistic database 404, including, e.g., a path-to-clent₁₀₄ chart 406, and a path-to-clent_{1 06} chart 408.

In general, implementing a VOIP system requires the network to be stable and have a low incidence of errors. Embodiments of the present invention monitor the network to insure that it provides the high performance, low error rate environment required by VOIP applications. If any VoIP link used on the network generates too many errors, or it becomes too saturated with traffic, the problem can be quickly and easily pin-pointed. Control thresholds are easily set to automatically monitor and report that all links on the network are healthy and able to provide the stability that VOIP systems need.

In one commercial product embodiment that can be marketed on a CD-ROM, a VOIP-implementation evaluation browser user-console 410 enables users to find network bottlenecks, view the current utilization of any network interface, locate errors and broadcast storms, isolate virus/worm outbreaks, and justify equipment/link upgrades by providing objective details on network usage. Next generation network monitoring includes automatic performance monitoring of all network interfaces, no lengthy setup should be required. It preferably adapts to network changes so no ongoing maintenance is required. It has a minimal network impact, because system 100 doesn't flood the network with empty requests. Alerts are issued when monitored interfaces go over threshold, providing real-time information on what the network is doing. Typical operations staff should be able to effectively use the solution within an hour. The installation is quick and easy installation, takes less than one hour to install and auto configure. The hardware requirements are minimal, and affordable.

System 100 is a network monitoring solution that automatically monitors all of the network interfaces and doesn't necessarily require customization or maintenance. The installation is simple and can ran on an old server being decommissioned. Included utility program preferably include Network Equipment Inventory, Support Contract Tracking, Device Uptime Reporting, Quick means to locate where IP and MAC addresses are connected to the network, and ways to determine when to schedule downtime on a device or an interface. The system is self-maintaining so users don't have to trim log files or maintain a database just to track the network's performance. System 100 tracks traffic flows in, out, and through the network switches to provide users with a picture of the performance of the network. Users can see which interfaces have the highest utilization, and where network errors come from. The initial installation and configuration is completed in under ten minutes with a Quick Configuration Wizard that scans the network and monitors all of the switches it discovers. When the network changes, and switches are added or removed, users can rapidly update the configuration using the Quick Configuration Wizard. It will detect new switches and include them in the configuration, and start monitoring again. A daily network “Weather Report” is preferably emailed to users to help users keep track of the health of the network. Users don't have to login to system 100 to get reports. Reports are fully customizable, users can add a company's logo or other custom information. Links on each report allow users to connect to the web page to analyze and fix problems. Telnet links for each switch allow users to check and change configurations. Users can keep/organize each report in an email system to maintain a history of the network's health. System 100 provides network performance information on each interface in the network so users can know which interfaces are over-utilized, and which interfaces have too many errors.

A Network Prescription function leads users to a healthier network. Each user presentation displays prescriptive information to suggest ways to improve performance and reduce errors. Browser 410 allows users to see the current utilization of any network interface. If someone needs to know if the network is experiencing a slowdown, users can look at current link saturation rates and determine if link is unusually slow. If users ask what switch and port an IP address exists, System 100 fix problem. Users are enabled to search through all of a device's ARP caches to convert an IP address to a MAC address, and then search for the MAC address on all of the switch ports to locate the individual port where the device is connected.

Users are enabled to securely access the network performance information wherever they are using Web browser, PocketPC, or Cellphone. Teleworking from a remote site is enabled with a low-bandwidth optimized user interface. All features that are available via the web interface are available on a PocketPC web interface. Being mobile provides users with the ability to resolve problems rapidly while still in the field. System 100 can monitor utilization and errors on router interfaces. Such allows users to keep track of performance on the Internet and other WAN links that are connected to the router. Each interface has its utilization tracked daily, weekly, monthly, and yearly. Users can watch overall trends of the usage and determine when they should consider adding or reducing bandwidth.

System 100 collects and displays the OSI services that each device reports. This lets users rapidly and accurately determine the purpose and function of each network device without having to perform a manual inventory. Each device on the network is also interrogated for information about its OS version, location, and administrative contact. This provides an efficient method to track device inventory information across the enterprise. Inventory information can be downloaded in CSV format for importing into spreadsheets for even greater reporting capability.

System 100 preferably keeps track of service contracts for each network device so the service contract information is accessible. Users are alerted to when service contracts are due to expire, system 100 sends out a monthly service contract report, and a reminder email is sent one month prior to each service contract's expiration, preventing lapses in support contracts.

Each device reports how long it has been online and servicing the network. This determines the general reliability and stability of the network hardware. Being familiar with this statistic helps users to evaluate when equipment should be replaced or serviced. System 100 users can monitor all of the SNMP manageable devices. Tracking errors on all interfaces on the network provides users with an unabridged vision of the network's health. Monitoring server interfaces permits detecting errors on server NIC's, e.g., duplex issues or collisions. Monitoring server interfaces for usage means that users can know when there's no usage on servers. Users can easily predict when there will be low usage on the server.

Watching each Internet link's usage can help detect abnormal usage. Typically, most Internet links have a lot of inbound traffic flows for servicing web browsers and other inbound information requests. Strange outbound traffic flows during certain hours may indicate inappropriate usage, like a hacker or illegal file sharing on the network. System 100 tracks the utilization back to a specific interface by checking each interface on the switch for a matching pattern of utilization to locate the specific machine that is generating the traffic.

FIG. 5 represents a method embodiment of the present invention for measuring network performance, and is referred to herein by the general reference numeral 500. The method 500 comprises a step 502 for sending an SNMP command from a manager to a remote device that requests information. A step 504 is for receiving an SNMP response at the manager from the remote device. A step 506 is for measuring the round-trip latency of between each SNMP command and response. Such steps are repeated at least twice to gather enough information for an inter-packet jitter calculation in a step 508. A step 510 counts any missing packets that occur in each SNMP command and response. A step 512 combines the round-trip latency, inter-packet jitter, and missing packets measurements into a quality score. Such quality score indicates the suitability of a network link out to the remote device to handle a real-time network service. A step 514 repeats the previous steps many times per hour. A step 516 then provides for measuring and graphing a history of latency, jitter, and packet loss. A step 518 will issue an alert if specific combinations of latency, jitter, and packet loss are detected, e.g., an email, pop-up message, instant message, syslog message, or web alert. If a step 520 is used for synchronizing a system clock at the manager with a system clock at the remote device, then a step 522 can query the remote device's system clock with an SNMP command, and a step 524 can divide the round-trop latency of an SNMP response into individual unidirectional sends. If a step 526 is used for counting the number of router hops used to communicate with the remote device with a traceroute-like mechanism, each hop can be tracked and analyzed in a step 528 so any source of significant latency may be reported. A step 530 is used for repeating the step of counting the number of router hops for multiple times per hour, so a step 532 can be used for measuring and graphing a history of the number of router hops out to the remote device. A step 534 provides for issuing an alert if the number of hops exceeds a particular value, and such alert includes at least one of an email, pop-up message, instant message, syslog message, or web alert.

While the present invention has been described with reference to several particular example embodiments, those skilled in the art will recognize that many changes may be made thereto without departing from the spirit and scope of the present invention, which is set forth in the following claims.

1. A method for measuring network performance, comprising:
sending an SNMP command from a manager to a remote device that requests information;
receiving an SNMP response at said manager from said remote device;
measuring the round-trip latency of between each SNMP command and response;
repeating the above steps at least twice to gather enough information for an inter-packet jitter calculation;
counting any missing packets that occur in each SNMP command and response;
combining measurements of round-trip latency, inter-packet jitter, and missing packets into a quality score;
wherein, said quality score indicates the suitability of a network link out to said remote device to handle a real-time network service.

2. The method of claim 1, further comprising:
repeating the steps multiple times per hour; and
measuring and graphing a history of latency, jitter, and packet loss.

3. The method of claim 1, further comprising:
issuing an alert if specific combinations of latency, jitter, and packet loss are detected, and takes the form of at least one of an email, pop-up message, instant message, syslog message, or web alert.

4. The method of claim 1, further comprising:
synchronizing a system clock at said manager with a system clock at said remote device; and
querying said remote device's system clock with an SNMP command; and
dividing the round-trop latency of an SNMP response into individual uni-directional sends.

5. The method of claim 1, further comprising:
counting the number of router hops used to communicate with the remote device with a traceroute-like mechanism, wherein each hop is tracked and analyzed so any source of significant latency may be reported.

6. The method of claim 5, further comprising:
repeating the step of counting the number of router hops for multiple times per hour; and
measuring and graphing a history of the number of router hops out to said remote device.

7. The method of claim 5, further comprising:
issuing an alert if the number of hops exceeds a particular value, and such alert includes at least one of an email, pop-up message, instant message, syslog message, or web alert.

8. A system for measuring network performance, comprising:
an SNMP manger for issuing commands to remote devices on a network associated with the delivery of real-time voice or video services;
a browser providing for a command console to control the SNMP manager;
a TTL probe for issuing traceroute tests and for analyzing network pathways and ICMP responses; and
a health statistic database for storing and organizing data generated by the TTL probe and SNMP manager, and responsive to user queries from the browser.

9. The system of claim 8, further comprising:
a synchronized system clock collocated at the SNMP manager and each of the remote devices, such that one-way packet latencies can be measured and their statistics collected for analysis and reporting.

10. A business model for measuring network performance, comprising:
selling a CD-ROM or a downloadable application program from a website on the Internet, wherein such program provides for:
sending an SNMP command from a manager to a remote device that requests information;
receiving an SNMP response at said manager from said remote device;
measuring the round-trip latency of between each SNMP command and response;
repeating the above steps at least twice to gather enough information for an inter-packet jitter calculation;
counting any missing packets that occur in each SNMP command and response; and
combining measurements of round-trip latency, inter-packet jitter, and missing packets into a quality score;
wherein, said quality score indicates the suitability of a network link out to said remote device to handle a real-time network service.
